(19) United States
(12) Patent Application Publication
(10) Pub. No.: US 2016/0263836 A1
(43) Pub. Date: Sep. 15, 2016

(54) THREE-DIMENSIONAL OBJECT FORMING SYSTEM

(71) Applicant: CANON KABUSHIKI KAISHA, Tokyo (JP)

(72) Inventors: Takehiro Yoshida, Tokyo (JP); Satomi Takaya, Kamo-gun (JP)

(21) Appl. No.: 15/065,695

(22) Filed: Mar. 9, 2016

(30) Foreign Application Priority Data
Mar. 11, 2015 (JP) 2015-048507

(51) Int. Cl. B29C 67/00

(52) U.S. Cl. CPC B29C 67/0088; B33Y 10/00

(57) ABSTRACT

A three-dimensional object forming system includes a forming unit that forms a three-dimensional object, a detecting unit that detects a remaining amount of material usable for forming the three-dimensional object, an input unit that inputs three-dimensional data, a converting unit that converts the three-dimensional data, a calculating unit that calculates a material amount to be used to form the three-dimensional object, and a display unit that displays a prediction result of the three-dimensional object based on the three-dimensional data.

### BACKGROUND

1. Field

Aspects of the present invention generally relate to a three-dimensional object forming system.

2. Description of the Related Art

In recent years, attention has been given to three-dimensional object forming techniques that are called additive manufacturing (AM), three-dimensional printing, rapid prototyping (RP), and the like (these techniques are herein collectively called a three-dimensional printing technique or a 3D printing technique).

Features of such techniques include forming a layer of an object at a single operation with a large amount of material, fixing a forming part to a lower layer by curing or solidifying on the basis of computer-controlled data, and repeating such operations in order to form the object.

Specifically, stereolithography (STL) data is generated from three-dimensional data (e.g., three-dimensional computer aided design (3D-CAD) data or point group data), and slice data that is necessary to form the three-dimensional object is further generated. The slice data is typically generated by a three-dimensional object forming apparatus (hereinafter also referred to as an apparatus) by adding a support area as necessary.

A formation material is determined according to the apparatus, and an object is formed in such a manner that, on the basis of the slice data, a material supply unit in the apparatus discharges the formation material and a support material in order to form a single layer, and such layers are stacked on top of one another.

In three-dimensional object formation, the apparatus receives data, specified by a controller, for forming the three-dimensional object and forms the three-dimensional object. However, the formation is stopped upon the depletion of the formation material.

Accordingly, in order not to deplete the material, a user always has to be careful about a remaining amount of material and supply of the material. If the user fails to do this, when the material is insufficient, the formation of the object is not completed, and the uncompleted object is a waste.

Japanese Patent Laid-Open No. 2010-37599 discloses a three-dimensional object forming apparatus, the apparatus including a formation material by using a cartridge. U.S. Pat. No. 7,996,101 discloses an apparatus that calculates a material amount that is necessary to form an object and a material amount contained within a cartridge, and that determines whether or not the material amount contained within the cartridge is sufficient. If the material amount within the cartridge is insufficient, the apparatus negates the material.

There is also software that calculates the volume of a 3D model from slice data thereof so that the necessary weight of the material can be estimated before the start of formation.

With such methods in which the cartridge containing the formation material is exchanged for a new one in order to prevent the lack of formation material, it is possible to prevent wastage of the formation material owing to failure in formation. However, with such methods, efficient use of the material is difficult, and user convenience is not high.

### SUMMARY

An embodiment of the present invention provides a three-dimensional object forming system, the system including a forming unit configured to form a three-dimensional object,

a detecting unit configured to detect a remaining amount of material usable for forming the three-dimensional object, an input unit configured to input three-dimensional data,
a converting unit configured to convert the three-dimensional data, a calculating unit configured to calculate a material amount to be used to form the three-dimensional object, and
a display unit configured to display the three-dimensional data, wherein based on a result of comparison between the detected remaining amount of material and the material amount to be used, information displayed on the display unit is changed.

Further features of aspects of the present invention will become apparent from the following description of exemplary embodiments with reference to the attached drawings.

### BRIEF DESCRIPTION OF THE DRAWINGS

FIG. 1 schematically illustrates a configuration of a three-dimensional object forming system according to an embodiment.

FIG. 2 specifically illustrates a controller of the three-dimensional object forming system according to the embodiment.

FIG. 3 is a flowchart illustrating control performed by the controller of the three-dimensional object forming system according to Example 1.

FIG. 4 is a flowchart illustrating processing for cases where formation of a three-dimensional object is not possible during the control performed by the controller of the three-dimensional object forming system according to Example 1.

FIG. 5 is a flowchart illustrating control performed by a controller of a three-dimensional object forming system according to Example 2.

FIG. 6 is a flowchart illustrating processing for cases where formation of a three-dimensional object is not possible during the control performed by the controller of the three-dimensional object forming system according to Example 2.

FIG. 7 is a flowchart illustrating control performed by a controller of a three-dimensional object forming system according to Example 3.

FIG. 8 is a flowchart illustrating processing for cases where formation of a three-dimensional object is not possible during the control performed by a controller of a three-dimensional object forming system according to Example 4.

FIG. 9 is a flowchart illustrating processing for cases where formation of a three-dimensional object is not possible during the control performed by a controller of a three-dimensional object forming system according to Example 5.

### DESCRIPTION OF THE EMBODIMENTS

Exemplary embodiments for implementing aspects of the present invention will be described below with reference to the attached drawings. Note that the scope of the aspects of the invention is not be limited to the dimensions, materials, forms, and relative arrangements of members, the procedure, controlling parameters, and target values in control processes, and the like described in the following embodiments unless otherwise specified.

### Embodiment

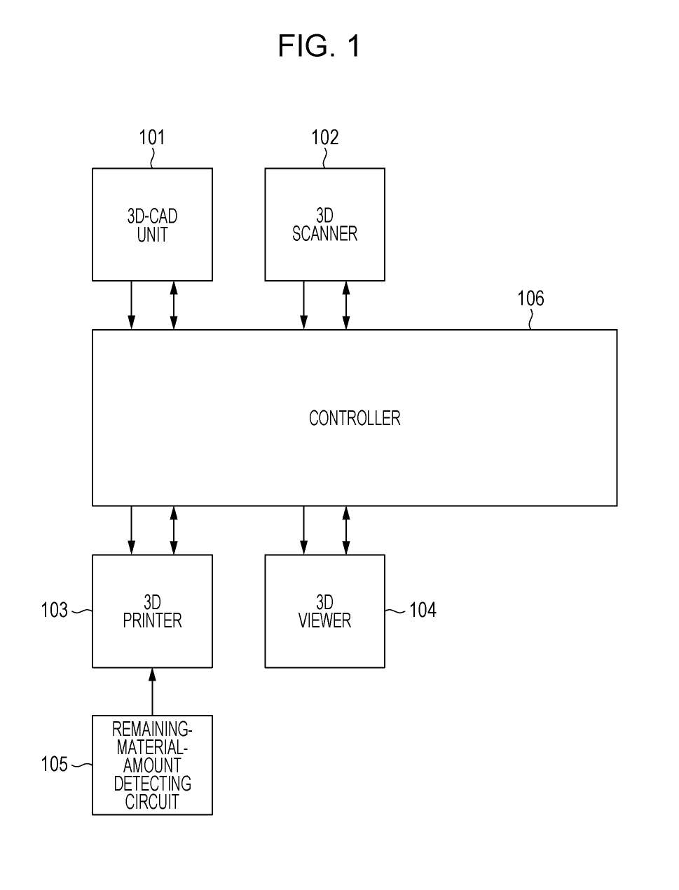

A configuration of a three-dimensional object forming system according to an embodiment of the present invention will be described with reference to the schematic diagram of the configuration illustrated in FIG. 1.

In FIG. 1, reference numeral 101 denotes a 3D-CAD unit that outputs CAD data for forming a three-dimensional object.

There is a type of CAD data that is defined by the ISO as an international standard called Standard for the Exchange of Product Model Data (STEP, ISO 10303). This standard was prepared by the ISO technical committee TC184/SC4. There are many other types of CAD data. The 3D-CAD unit 101 outputs 3D-CAD data to a controller 106, which will be described later. The 3D-CAD unit 101 is connected to the controller 106 via a control line, and signals such as a command from the controller 106 and a response from the 3D-CAD unit 101 are controlled.

Reference numeral 102 denotes a three-dimensional (3D) scanner that outputs three-dimensional data obtained by scanning a three-dimensional object as point group data (data of a set of vertexes in a three-dimensional space; also referred to as point cloud data). The output point group data is input to the later-described controller 106. The 3D scanner 102 is connected to the controller 106 via a control line, and signals such as a command from the controller 106 and a response from the 3D scanner 102 are controlled.

Reference numeral 103 denotes a 3D printer (also referred to as a three-dimensional object forming apparatus) that receives three-dimensional data from the controller 106 and that forms a three-dimensional object. Examples of the three-dimensional data that the 3D printer 103 receives include STL data. The STL data represents a three-dimensional form as an aggregate of small triangles. The 3D printer 103 is connected to the controller 106 via a control line, and signals such as a command from the controller 106 and a response from the 3D printer 103 are controlled.

Reference numeral 104 denotes a 3D viewer that receives the three-dimensional data from the controller 106 and that generates three-dimensional data for display. Examples of the three-dimensional data that the 3D viewer 104 receives include extensible virtual world description language (XVL) data, which is light three-dimensional data. The 3D viewer 104 is connected to the controller 106 via a control line, and signals such as a command from the controller 106 and a response from the 3D viewer 104 are controlled.

Reference numeral 105 denotes a remaining amount of material detecting circuit that detects a remaining amount of material for forming the three-dimensional object in the 3D printer 103. Information representing the remaining amount of material is output to the 3D printer 103. For example, a material is stored in a box having a predetermined size, and this box is vibrated in order to diffuse the material. By detecting the height of the material in the box, the material amount can be detected. Alternatively, the remaining amount of material can be calculated by subtracting, from a material amount that is set at the time of initialization of the three-dimensional object forming apparatus, a material amount that is used for formation, or can be calculated from the weight of the formation material.

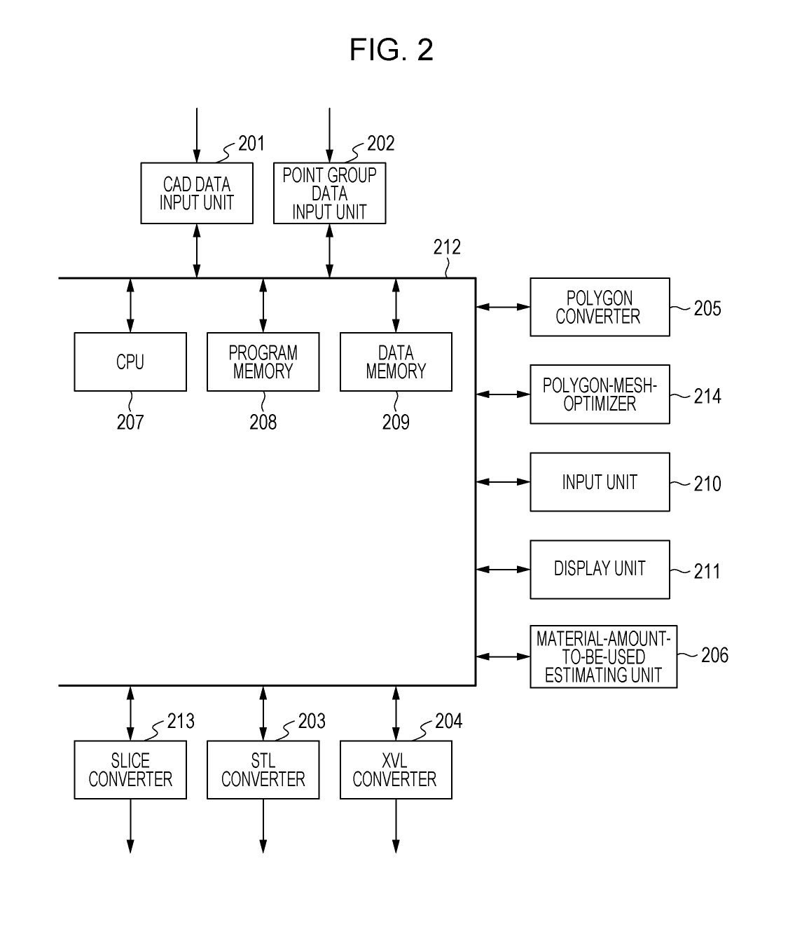

Reference numeral 106 denotes a controller. The controller 106 is specifically illustrated in FIG. 2. Blocks that will be described later are connected to each other via a system bus 212.

The controller 106 performs data conversion that is necessary to form a three-dimensional object.

Specifically, three-dimensional data (e.g., 3D-CAD data and point group data) that is input is converted into polygon data or converted into polygon mesh data and optimized, the polygon data or polygon mesh data is converted into STL data, and the STL data is converted into slice data in accordance with the apparatus. The slice data is three-dimensional data that is necessary as data to be output to the three-dimensional object forming apparatus.

Referring to FIG. 2, a CAD data input unit 201 is a block that receives signals output from the 3D-CAD unit 101. The signals correspond to 3D-CAD data, and the input 3D-CAD data is stored in, for example, a data memory 209, which will be described later, through the system bus 212.

A point group data input unit 202 is a block that receives signals output from the 3D scanner 102. The signals correspond to point group data, and the input point group data is stored in, for example, the later-described data memory 209 through the system bus 212.

An STL converter 203 is a block that receives, through the system bus 212, three-dimensional data that is converted into polygon data and is optimized by a polygon-mesh-optimizer 214, which will be described later, or three-dimensional data that is converted into polygon data by a polygon converter 205, which will be described later, and that converts the three-dimensional data into STL data. The STL data obtained by this conversion is transferred to a slice converter 213, which will be described later, through the system bus 212.

The slice converter 213 is a block that receives the STL data through the system bus 212 and that outputs slice data to the 3D printer 103 through the system bus 212. The slice converter 213 also performs variable magnification processing on the slice data. The variable magnification processing is realized by scaling cross-sectional slice data (X, Y) and also by scaling data in the height direction (Z).

An XVL converter 204 is a block that receives, through the system bus 212, three-dimensional data that is converted into polygon data and optimized by the later-described polygon-mesh-optimizer 214 or three-dimensional data that is converted into polygon data by the later-described polygon converter 205. The XVL converter 204 then converts the three-dimensional data into XVL data and outputs the XVL data to the 3D viewer 104.

The polygon converter 205 is a block that receives the CAD data stored in the data memory 209 and that converts this data into polygon data. Note that the CAD data may be input directly from the CAD data input unit 201 without being stored in the data memory 209 and may be converted into polygon data. The polygon data is stored in, for example, the later-described data memory 209 through the system bus 212.

The polygon-mesh-optimizer 214 is a block that receives point group data stored in the data memory 209 and that converts this data into polygon mesh data and optimizes this data. Processing for converting point group data into polygon data needs to involve optimization with more complex and varied error corrections than those in processing for converting 3D-CAD data into polygon data. Therefore, the processing for converting point group data into polygon data and the processing for converting 3D-CAD data into polygon data are separately described in this embodiment, but may be performed as single processing for conversion into polygon data.

Note that the point group data may be input directly from the point group data input unit 202 without being stored in the data memory 209 and may be converted into polygon data. The polygon data is stored in, for example, the later-described data memory 209 through the system bus 212.

A unit 206 for estimating a material amount to be used (hereinafter referred to as a material-amount-to-be-used estimating unit 206) is a block that receives, for example, the above-described STL data and slice data and that estimates, on the basis of such three-dimensional data, a material amount to be used to form the three-dimensional object. The material-amount-to-be-used estimating unit 206 then outputs the estimation result. For example, in a case of forming a three-dimensional object by stacking layers on the basis of two-dimensional information, if the thickness of a two-dimensional object (the length in the Z direction) to be formed is d, the material amount to be used is equal to the value obtained by multiplying, by the thickness d, the sum of areas of the first to the last planes to be stacked.

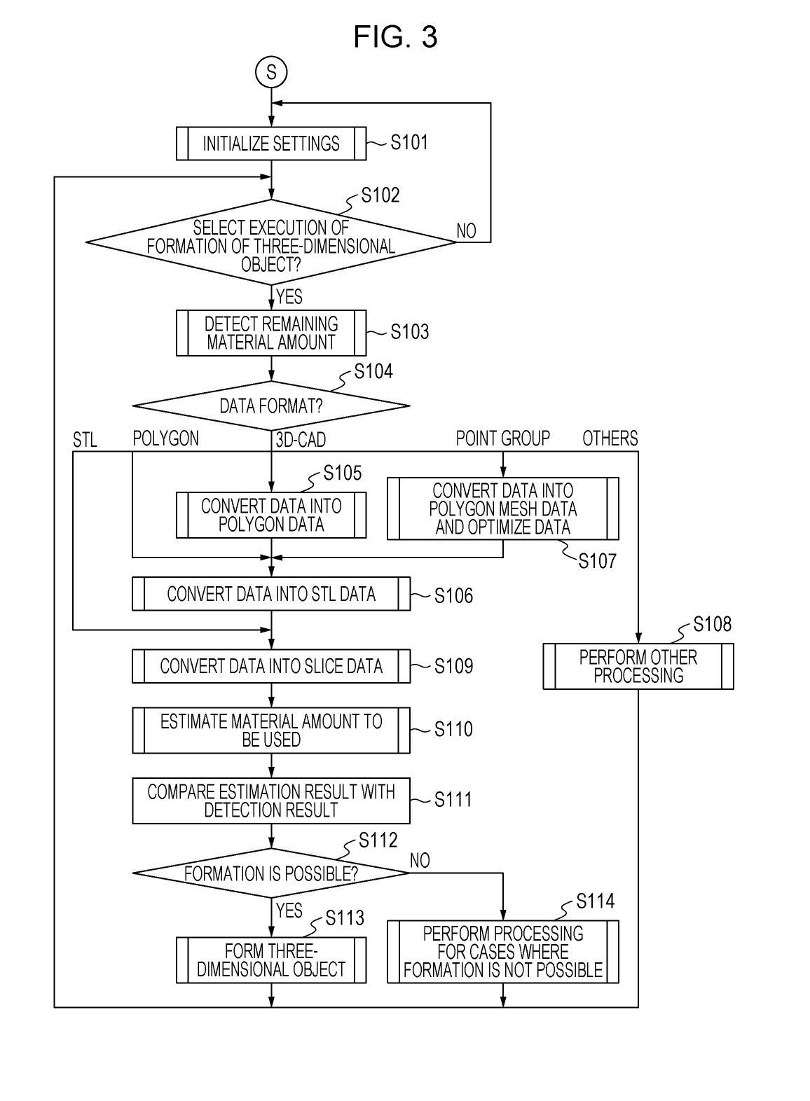

A central processing unit (CPU) 207 performs control illustrated in FIG. 3 and in subsequent figures on the basis of control programs stored in a program memory 208, which will be described later.

The program memory 208 stores programs for performing control.

The data memory 209 stores 3D-CAD data, point group data, polygon data, STL data, slice data, XVL data, operation history data, and the like.

An input unit 210 detects information input to an operation unit, which is not illustrated.

At least if the remaining amount of material in the 3D printer is less than a necessary material amount to be used to form a three-dimensional object, three-dimensional data of a three-dimensional object that can be formed with the remaining amount of material can be displayed on a display unit, and a user input can be detected. This data is output to the system bus 212. The expression “necessary material amount to be used to form a three-dimensional object” means a material amount that is necessary to normally complete the formation of a three-dimensional object on the basis of three-dimensional data for which a formation instruction has been made, and the same applies to the following description.

A display unit 211 displays various kinds of information. At least if the remaining amount of material in the 3D printer is less than the necessary material amount to be used to form a three-dimensional object, the display unit 211 can display alternative three-dimensional data. The display unit 211 receives information through the system bus 212 and displays the information.

The 3D printer 103 notifies the controller 106 of the following attribute information as notification information.

Examples of the notification information include information on external dimensions of a three-dimensional object that can be formed by the 3D printer, such as the maximum external dimensions of three-dimensional data at X, Y, and Z coordinates, information on thicknesses of slices usable for forming the three-dimensional object, information on resolution of each piece of slice data that is used to form the three-dimensional object, and the remaining amount of material usable for forming the three-dimensional object. Note that the notification information is not limited to the above examples.

On the other hand, the controller 106 notifies the 3D printer 103 of determined information among the above pieces of notification information.

FIG. 3 and subsequent figures illustrate a specific example of control performed by the controller 106 according to an embodiment of the present invention.

### Example 1

Examples according to the embodiment of the present invention will be described below with reference to the attached drawings. The following examples according to the embodiment illustrate exemplary examples of embodying aspects of the present invention, which are specific examples of configurations described in the scope of claims.

According to Example 1, if it is determined that the current remaining amount of material is too small to normally form a three-dimensional object, the formation of the three-dimensional object is not started. If the detected remaining amount of material is less than a material amount to be used, this fact and error notification are displayed. Further, three-dimensional data, calculated from the remaining amount of material, for which a three-dimensional object can be formed is displayed.

This is effective in that a user can supply the material to the 3D printer in order to execute the formation of the three-dimensional object having the actual size, and in addition, if there is no material to supply, the user can convert the three-dimensional object in such a manner as to be formed with the remaining amount of material in order to execute the formation of the three-dimensional object.

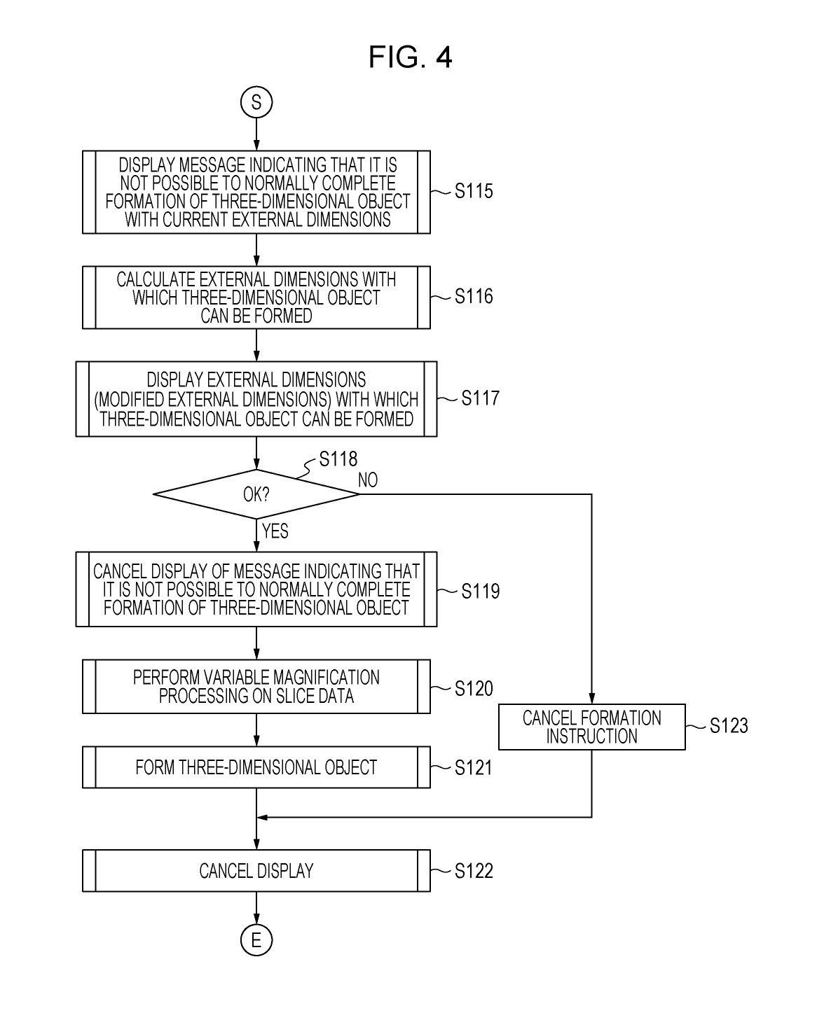

A specific example of the control performed by the controller 106 according to Example 1 of an aspect of the present invention will be described with reference to FIGS. 3 and 4.

Referring to FIG. 3, when a system is started, first, settings are initialized in step S101. Then, in step S102, information is obtained from the input unit 210, and it is determined whether or not the execution of the formation of a three-dimensional object has been selected by a user operation. If the execution of the formation of a three-dimensional object has been selected, the process proceeds to step S103; if the execution of the formation of a three-dimensional object has not been selected, the process returns to step S101.

Then, in step S103, a command and a response are transmitted through a control line connected to the 3D printer 103, whereby a remaining amount of material is detected. In subsequent step S104, the data format of input data is determined.

If the data format is 3D-CAD, the process proceeds to step S105 where the data is converted into polygon data. Then, in step S106, the polygon data is converted into STL data, and in step S109, the STL data is converted into slice data.

If the input data is STL data in step S104, the process proceeds to step S109 where the STL data is converted into slice data, and subsequent processing is performed. If the input data is polygon data in step S104, the process proceeds to step S106 where the polygon data is converted into STL data, and the processing in step S109 and subsequent processing are performed.

If the input data is point group data in step S104, the process proceeds to step S107 where the point group data is converted into polygon mesh data and is optimized, and then the process proceeds to processing in step S106 where the polygon mesh data is converted into STL data and subsequent processing.

Then, in step S110, the material-amount-to-be-used estimating unit 206 is started and estimates, through calculation from the slice data, a necessary material amount to be used to form the three-dimensional object.

Then, in step S111, the remaining amount of material in the 3D printer, which is detected in step S103, is compared with the result of estimation of the material amount to be used, which is calculated in step S110. In subsequent step S112, it is determined whether or not the three-dimensional object can be formed. As a result, if the three-dimensional object can be formed, the process proceeds to step S113 where the three-dimensional object is formed, and the process returns to step S102. If it is not determined that the three-dimensional object can be formed in step S112, the process proceeds to step S114 where processing for cases where it is not possible to form the three-dimensional object (cases where the formation is not possible) is performed.

The expression “whether or not the three-dimensional object can be formed” means, on the basis of three-dimensional data for which a formation instruction has been made, whether or not it is possible to normally complete the formation of the three-dimensional object, more specifically, whether or not it is possible to form the 100% complete three-dimensional object.

If the input data is other data in step S104, the process proceeds to step S108 where the other kind of processing is performed, and the process returns to step S102.

In the cases described above, it is possible to normally complete the formation of the three-dimensional object on the basis of the three-dimensional data with the remaining amount of material.

Next, with reference to FIG. 4, a description will be given of processing for cases where the formation is not possible, which is performed in step S114 if it is not possible to normally complete the formation of the three-dimensional object on the basis of the three-dimensional data (the percentage of formation completion is below 100%) owing to the lack of remaining amount of material.

As illustrated in FIG. 4, upon starting the processing for cases where the formation is not possible (step S114 in FIG. 3), in step S115, regarding the three-dimensional data for which a formation instruction has been made, a message indicating that it is not possible to normally complete the formation of the three-dimensional object with the current external dimensions is displayed on the display unit 211.

In subsequent step S116, from the remaining amount of material detected in step S103 and the estimated material amount to be used to form the three-dimensional object, which is detected in step S110, external dimensions with which it is possible to normally complete the formation of the three-dimensional object (the percentage of formation completion is 100%) are calculated. In the calculation of the external dimensions with which it is possible to normally complete the formation of the three-dimensional object, if the external dimensions are scaled down equally in each of the three-dimensional coordinate axes, which are X, Y, and Z coordinate axes, the scaling factor is equal to the cube root of (a) where a=(the remaining amount of material/the material amount to be used).

Then, in step S117, external dimensions (modified external dimensions) with which it is possible to normally complete the formation of the three-dimensional object on the basis of the calculation result obtained in step S116 are displayed on the display unit 211 as a prediction result. In subsequent step S118, a user input with respect to the external dimensions (modified external dimensions) displayed on the display unit 211, with which it is possible to normally complete the formation of the three-dimensional object, is obtained from information of the input unit 210, and determination is performed. If the input is determined as OK in step S118, it is determined to continue an instruction for forming the three-dimensional object with the external dimensions (modified external dimensions) displayed in step S117, and accordingly, the process proceeds to step S119. If the input is not determined as OK, the process proceeds to step S123 where the instruction for forming the three-dimensional object is stopped, and the process proceeds to step S122.

In step S119, display of a message indicating that it is not possible to normally complete the formation of the three-dimensional object with the current external dimensions on the display unit 211 is cancelled. Then, in step S120, the slice converter 213 also performs variable magnification processing on the slice data. Then, in step S121, the 3D printer 103 forms the three-dimensional object, and the process proceeds to step S122 where display of the external dimensions with which it is possible to normally complete the formation of the three-dimensional object on the display unit 211 as a prediction result is cancelled.

As described above, according to Example 1, the necessary material amount is calculated from the slice data, and if it is not possible to normally complete the formation of the three-dimensional object with the current remaining amount of material, notification is displayed, and also external dimensions with which it is possible to normally complete the formation of the three-dimensional object with the remaining amount of material are proposed. Accordingly, the user does not fail to form the object, which prevents wastage of the formation material, and the user can complete the formation of the object with the remaining material by changing the external dimensions.

Regarding a case where the remaining amount of material is sufficient to form a three-dimensional object if the external dimensions are scaled down from 100% formation completion, the above Example has illustrated scaling down of the external dimensions equally in each of the three-dimensional axes in accordance with the remaining amount of material.

However, without being limited to the above Example, the three-dimensional object can be made hollow and the wall thickness can be reduced with the volume fixed. Alternatively, the three-dimensional object can be scaled down in one of the X, Y, and Z coordinate axes with the volume fixed. For example, the width (X), the depth (Y), and the outer periphery (XY) can be scaled down with the volume and the height (Z) fixed, or the height (Z) can be scaled down with the volume and the outer periphery (XY) fixed.

### Example 2

Although slice data of three-dimensional data is used in Example 1 in order to calculate the necessary material amount to be used to form the three-dimensional object, the necessary material amount can also be estimated from STL data.

In Example 2, therefore, the process is performed more efficiently by using STL data instead of slice data. That is, the process can be performed more rapidly if it is possible to use the STL data to estimate through calculation the necessary material amount to be used to form the three-dimensional object. In such a case, if the formation is not possible, notification can be displayed without performing processing for converting the STL data into slice data.

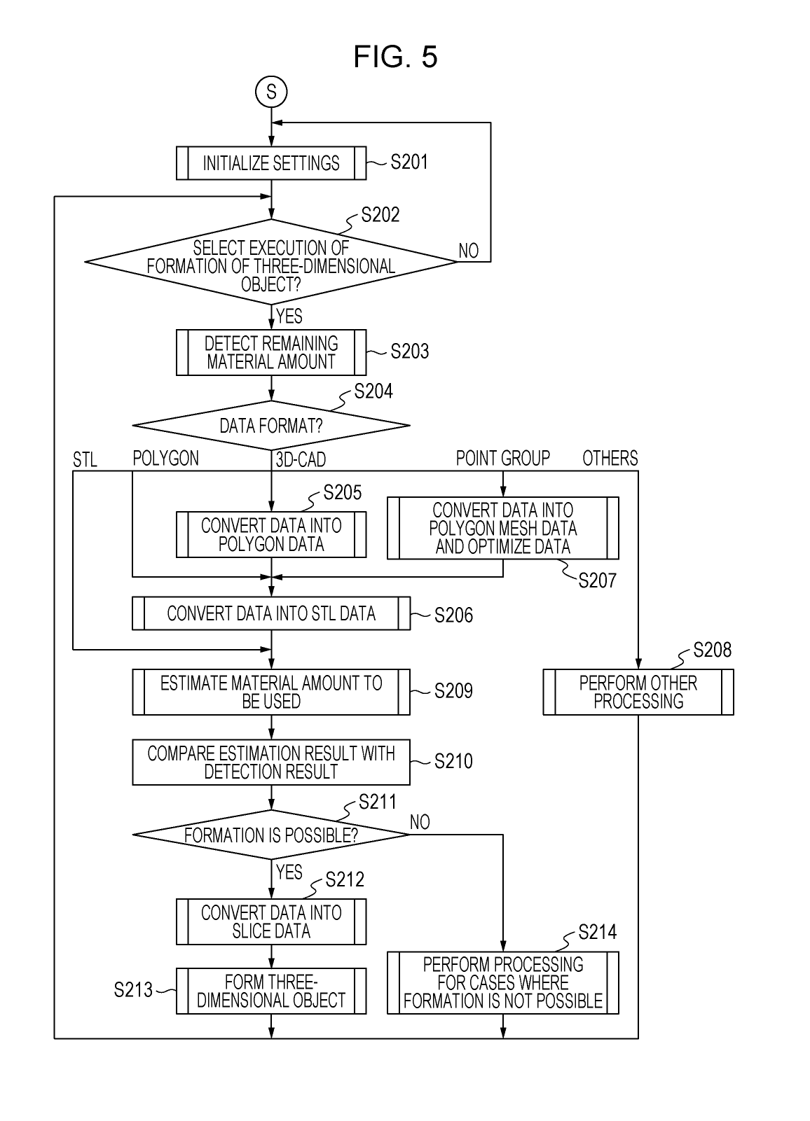

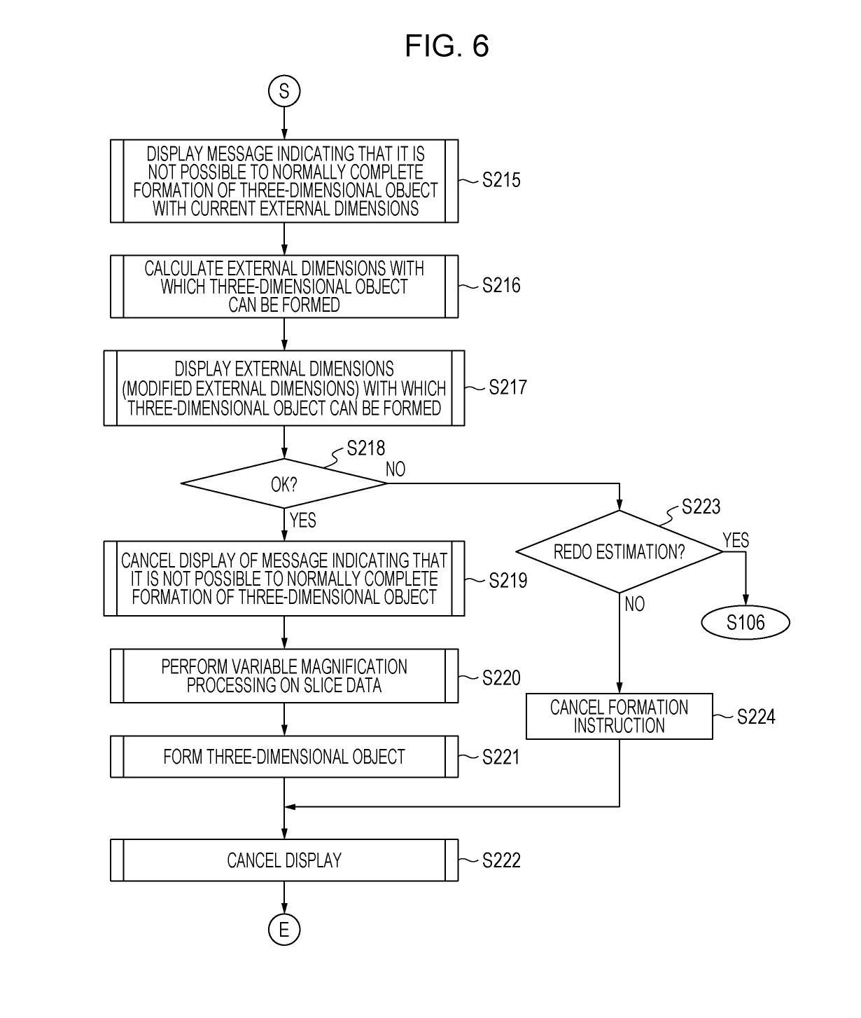

As differences in Example 2 from Example 1, FIGS. 5 and 6 illustrate a specific example of control performed by the controller 106 according to Example 2 of an aspect of the present invention.

Description of substantially the same processing as that in Example 1 will be omitted, and processing specific to Example 2 will be described.

As illustrated in FIG. 5, steps S201 to S208 correspond to steps S101 to S108 in FIG. 3 and are performed in substantially the same manner as in Example 1.

After the conversion into STL data in step S206, in step S209, the material-amount-to-be-used estimating unit 206 is started and estimates, through calculation from the STL data, a necessary material amount to be used to form the three-dimensional object.

Here, in a case where the form based on the three-dimensional data is not hollow (the form is solid), it is easy to calculate the necessary material amount to be used to form the three-dimensional object also from STL data. In a case where the form based on the three-dimensional data is hollow, the material amount actually necessary is less than the estimated amount. Processing in such a case will be described later with reference to FIG. 6.

On the basis of the comparison in step S210 between the remaining amount of material in the 3D printer, which is detected in step S203, and the result of estimation of the material amount to be used, which is calculated from STL data in step S209, it is determined in step S211 whether or not the three-dimensional object can be formed. As a result, if it is determined that the three-dimensional object can be formed, the process proceeds to step S212 where the slice converter 213 is started and converts the three-dimensional data into slice data, and in subsequent step S213, the three-dimensional object is formed. Then, the process returns to step S202.

On the other hand, if it is not determined that the three-dimensional object can be formed in step S211, the process proceeds to step S214 where processing for cases where the formation is not possible is performed. The following description will be given with reference to FIG. 6. Steps S215 to S222 correspond to steps S115 to S122 in FIG. 4 and are performed in substantially the same manner as in Example 1.

As illustrated in FIG. 6, the processing for cases where the formation is not possible (step S214 in FIG. 5) is started, and external dimensions (modified external dimensions) with which it is possible to normally complete the formation of the three-dimensional object on the basis of the calculation result obtained in step S216 are displayed on the display unit 211 as a prediction result (step S217). In subsequent step S218, if a user input is not OK, the process proceeds to step S223 where checking for the necessity to redo the estimation is displayed on the display unit 211. If the user input is OK, the process proceeds to step S106 in FIG. 1 where data conversion into slice data is performed (step S109), and subsequent processing is performed.

As described above, it is easy to estimate the necessary material amount from STL data if the form based on the three-dimensional data is not hollow. However, if the form based on the three-dimensional data is hollow, the estimation may include errors. In such a case, the user is allowed to select redoing the estimation in order to estimate the necessary material amount through calculation from slice data.

According to Example 2, since the necessary material amount is calculated from the STL data before being converted into slice data as described above, the determination is performed more rapidly as to whether or not the three-dimensional object can be formed, and, in cases where the formation is not possible, unnecessary processing for conversion into slice data is not performed.

Therefore, if it is possible to estimate the necessary material amount through calculation from STL data, by determining whether or not the three-dimensional object can be formed without data conversion into slice data, it becomes possible to reduce the time before the determination and the processing time before the formation of the three-dimensional object.

### Example 3

Examples 1 and 2 have illustrated control in which the necessary material amount to be used to form the three-dimensional object is estimated through calculation from three-dimensional data. In contrast, in Example 3, as long as the remaining amount of material is greater than or equal to a predetermined amount, control in which the necessary material amount to be used to form the three-dimensional object is estimated is not performed, or control in which the estimated amount is compared with the remaining amount of material is not performed.

If the material amount to be used to form the three-dimensional object is estimated every time the three-dimensional object is to be formed, the time for such processing may be wasted. If it is determined that the remaining amount of material is greater than or equal to a predetermined amount before the formation of the three-dimensional object is started, the three-dimensional object can surely be formed with the current external dimensions. Therefore, in such a case, control in which the material amount to be used to form the three-dimensional object is estimated through calculation is not performed. Thus, processing time can be saved. Note that the predetermined amount set for the remaining amount of material corresponds to, for example, the maximum external dimensions of a three-dimensional object that can be formed by the 3D printer that is instructed to output the object.

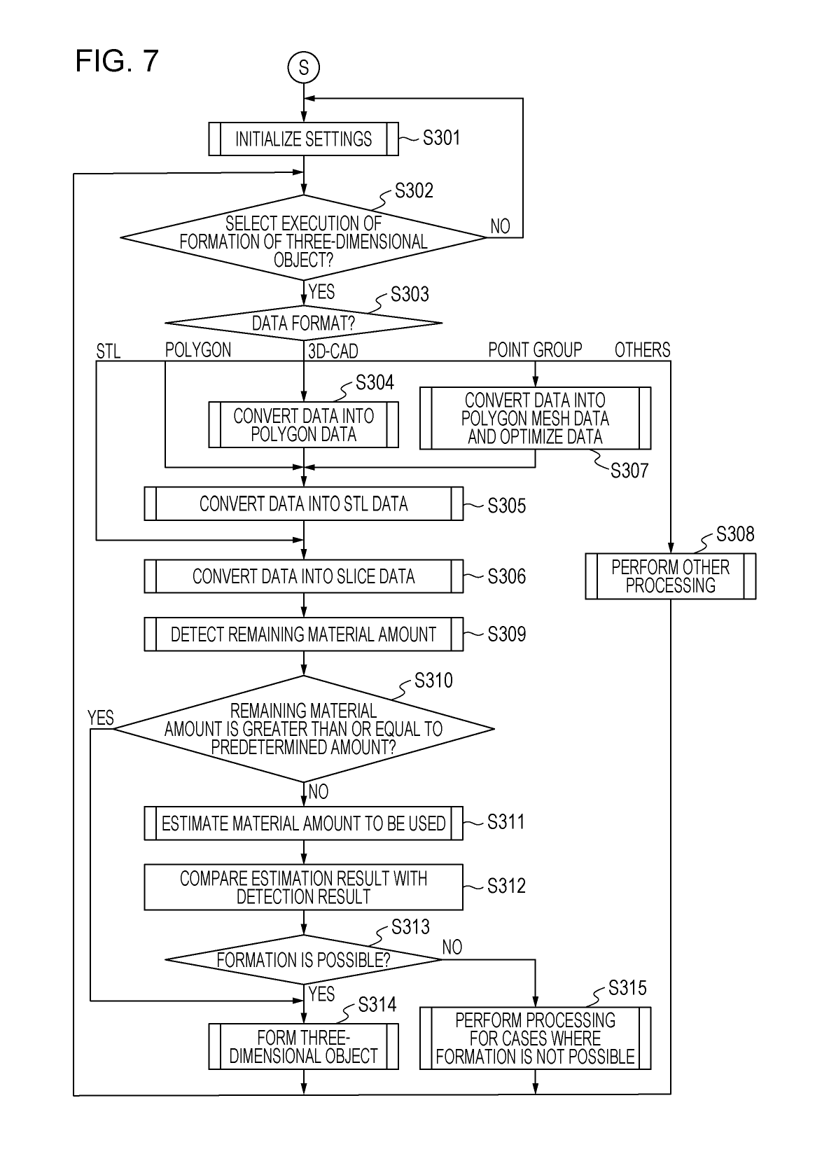

As differences in Example 3 from Example 1, FIG. 7 illustrates a specific example of control performed by the controller 106 according to Example 3 of an aspect of the present invention.

Description of substantially the same processing as that in Example 1 will be omitted, and processing specific to Example 3 will be described.

As illustrated in FIG. 7, steps S301 to S309 correspond to steps S101 to S109 FIG. 3 and are performed in substantially the same manner as in Example 1.

In step S309 in FIG. 7, a command and a response are transmitted through a control line connected to the 3D printer 103, whereby a remaining amount of material is detected. Then, in step S310, it is determined whether or not the detected remaining amount of material is greater than or equal to the predetermined amount. If the remaining amount of material is determined to be greater than or equal to the predetermined amount, the process proceeds to step S314 where the three-dimensional object is formed.

On the other hand, if the remaining amount of material is not greater than or equal to the predetermined amount in step S310, the process proceeds to step S311 where the material-amount-to-be-used estimating unit 206 is started and estimates a material amount to be used, and subsequent processing is performed in substantially the same manner as in Example 1.

According to Example 3, as described above, if it is determined that the remaining amount of material is greater than or equal to the predetermined amount before the start of the formation of the three-dimensional object, the material amount to be used to form the three-dimensional object is not estimated. Thus, processing time can be saved.

Note that the remaining amount of material can be controlled also in such a manner that the height (Z) is not limited to a certain value in a case of using a three-dimensional object forming apparatus to which the formation material can be supplied during the formation.

### Example 4

Examples 1 and 2 have illustrated control in which the apparatus can form a three-dimensional object on the basis of the remaining amount of material in the three-dimensional object forming apparatus. However, depending on the factor of scaling down the external dimensions, the user may not need the three-dimensional object any longer. Therefore, it is not always necessary to form the three-dimensional object.

Accordingly, in Example 4, if the external dimensions are lower than or equal to a predetermined percentage, for example 50%, with respect to 100% completion percentage, modified three-dimensional data with which it is possible to form a three-dimensional object is not displayed.

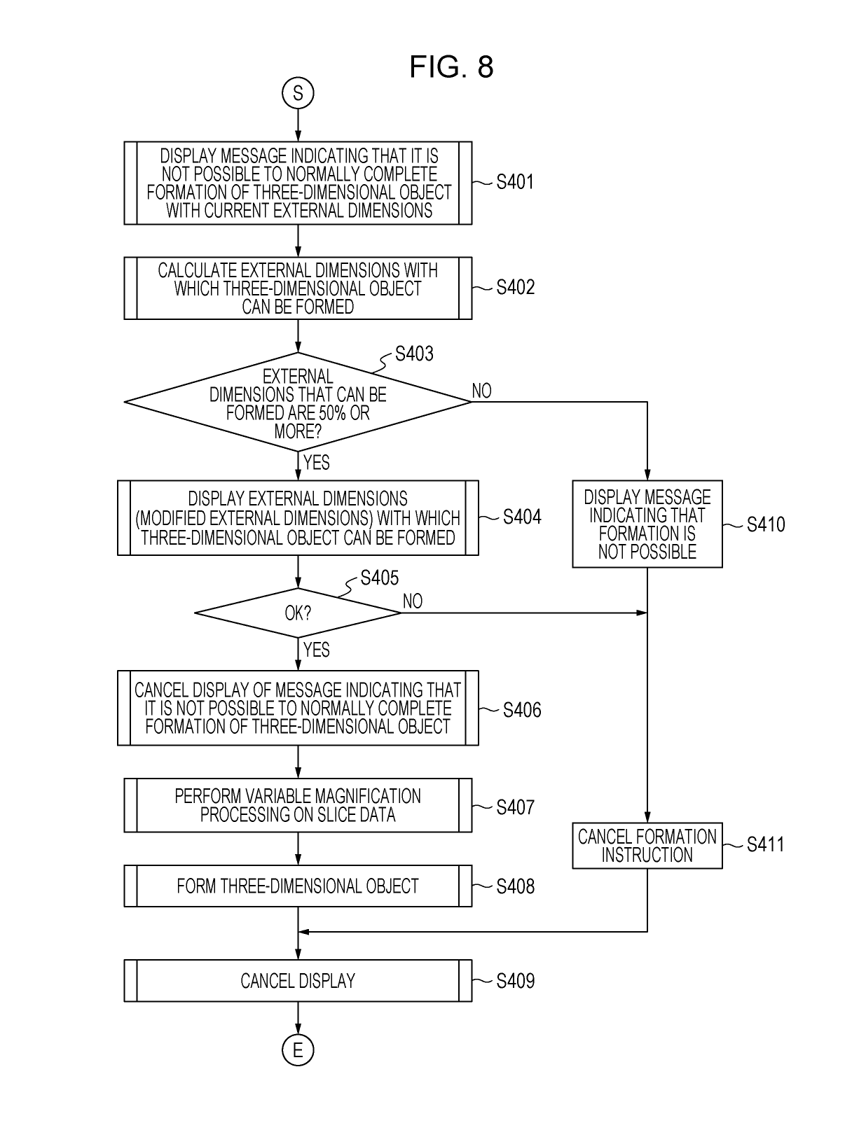

As differences in Example 4 from Example 1, FIG. 8 illustrates a specific example of control performed by the controller 106 according to Example 4 of an aspect of the present invention.

Description of substantially the same processing as that in Example 1 will be omitted, and processing specific to Example 4 will be described.

Substantially the same processing as that in FIG. 3 is performed in the same manner as in Example 1, and processing for cases where the formation is not possible in steps S401 and S402 in FIG. 8 correspond to processing in steps S115 and S116 in FIG. 4.

As illustrated in FIG. 8, upon starting the processing for cases where the formation is not possible (step S114 in FIG. 3), in step S401, a message indicating that it is not possible to normally complete the formation of the three-dimensional object with the current external dimensions is displayed on the display unit 211. Then, in step S402, external dimensions (modified external dimensions) with which it is possible to normally complete the formation of the three-dimensional object are calculated on the basis of the remaining amount of material. Then, in step S403, it is determined whether or not the external dimensions with which it is possible to normally complete the formation of the three-dimensional object are greater than or equal to 50% with respect to the original external dimensions of the three-dimensional data, which correspond to 100%.

If the external dimensions with which it is possible to normally complete the formation of the three-dimensional object are greater than or equal to 50%, the process proceeds to step S404 where the external dimensions with which it is possible to normally complete the formation of the three-dimensional object with the current remaining amount of material are displayed. On the other hand, if the external dimensions with which it is possible to normally complete the formation of the three-dimensional object are less than 50%, the process proceeds to step S410 where a message indicating that the formation is not possible is displayed on the display unit 211. Then, in step S411, processing for stopping the formation is performed, and in step S409, display of confirmation messages on the display unit S211 is cancelled.

In step S405, a user input with respect to the external dimensions (modified external dimensions) displayed on the display unit 211, with which it is possible to normally complete the formation of the three-dimensional object, is obtained from information of the input unit 210, and determination is performed. If the input is determined as OK in step S405, it is determined to continue an instruction for forming the three-dimensional object with the external dimensions (modified external dimensions) displayed in step S404. Accordingly, the process proceeds to step S406 where display of the message indicating that it is not possible to normally complete the formation of the three-dimensional object in step S401 is cancelled. Then, in step S407, the slice converter 213 also performs variable magnification processing on slice data. In subsequent step S408, the 3D printer 103 forms the three-dimensional object, and the process proceeds to step S409.

On the other hand, if the input is not determined as OK in step S405, the process proceeds to step S411 where an instruction for forming the three-dimensional object is stopped, and the process proceeds to step S409.

In step S409, display of the external dimensions, with which it is possible to normally complete the formation of the three-dimensional object, on the display unit 211 as a prediction result, is cancelled.

If the external dimensions are lower than or equal to 50% as the predetermined percentage with respect to 100% completion percentage, by not displaying modified external dimensions in the above manner, it becomes possible to prevent unnecessary proposal of changing in dimensions.

Note that the predetermined percentage in the above Example is not limited to 50%, and the user can set any value.

### Example 5

In Examples 1 and 2, if it is determined that it is not possible to normally complete the formation of the three-dimensional object with the current remaining amount of material, the formation of the three-dimensional object is not started. In addition, if the detected remaining amount of material is less than a material amount to be used, this fact and error notification are displayed. Further, modified external dimensions are displayed in which the external dimensions are scaled down in such a manner that the three-dimensional object can be formed with the remaining amount of material. In response to a user's instruction, the formation of the three-dimensional object with the modified external dimensions is executed.

In Example 5, an operation unit includes a selection unit for selecting whether the proposal of the modified external dimensions for the above control is valid or invalid, and control may be performed in accordance with the selection unit.

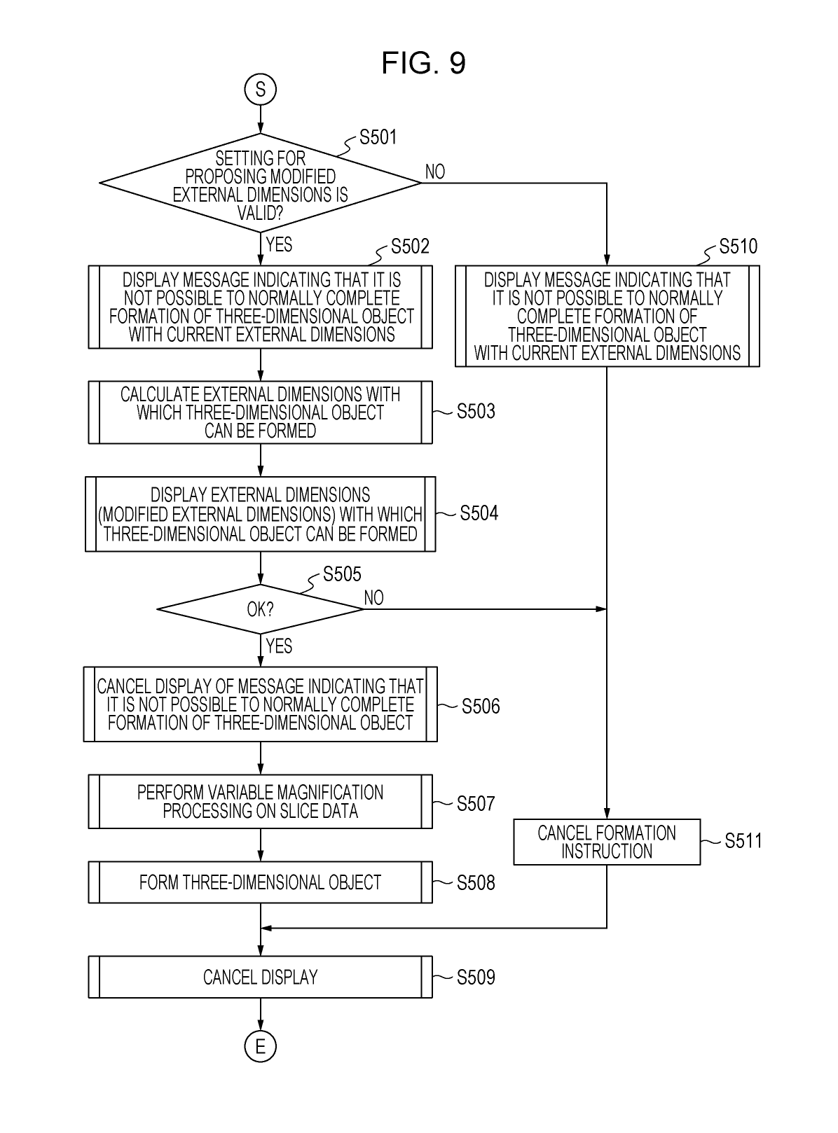

As differences in Example 5 from Example 1, FIG. 9 illustrates a specific example of control performed by the controller 106 according to Example 5 of an aspect of the present invention.

Description of substantially the same processing as that in Example 1 will be omitted, and processing specific to Example 5 will be described. The same processing as that in FIG. 3 is performed in substantially the same manner as in Example 1, and therefore description thereof will be omitted.

As illustrated in FIG. 9, upon starting the processing for cases where the formation is not possible (step S114 in FIG. 3), in step S501, information is input to the input unit 210. At this time, if the proposal of modified external dimensions is valid in accordance with setting that is made in advance, the process proceeds to step S502, and subsequent processing that is substantially the same as in Example 1 is performed.

On the other hand, if the setting is not made in such a manner that the proposal of modified external dimensions is valid in step S501 (the proposal is invalid), the process proceeds to step S510 where a message indicating that it is not possible to normally complete the formation of the three-dimensional object with the current external dimensions is displayed on the display unit 211. In subsequent step S511, an instruction for forming the three-dimensional object is stopped, and the process proceeds to step S509.

In step S509, display of external dimensions, with which it is possible to normally complete the formation of the three-dimensional object, on the display unit 211 as a prediction result, is cancelled.

In the above manner, only in a case where a user wishes to validate control in which modified external dimensions are proposed, the dimensions being obtained by scaling down the external dimensions in order to form a three-dimensional object with the remaining amount of material, the user can make the setting in such a manner as to validate this control. Even if the completion percentage of an object to be formed does not reach 100%, the user may wish to form the object without scaling down the external dimensions. To cope with such a situation, if the user is allowed to set the proposal as valid and invalid in accordance with the setting that is made in advance, the above user needs can be satisfied.

### Example 6

In Example 6, the predetermined amount set for the remaining amount of material in Example 3 is set in such a manner as to include a support material. For example, the predetermined amount set for the remaining amount of material may be a value obtained by multiplying, by 1.2, the maximum external dimensions (maximum volume) of a three-dimensional object that can be formed by the 3D printer. Accordingly, the three-dimensional object can surely be formed in Example 3 also in a case of using a support material.

As described above, according to an embodiment of the present invention, in a three-dimensional object forming system, if it is not possible to normally complete the formation of a three-dimensional object on the basis of three-dimensional data with the current remaining amount of material, a notification thereof is displayed, and in addition, external dimensions with which it is possible to normally complete the formation of the three-dimensional object with the current remaining amount of material are proposed. Accordingly, the user does not fail to form the object, which prevents wastage of the formation material, and the user can complete the formation of the object by changing the external dimensions.

Note that the above Examples have illustrated the controller including the 3D printer. However, aspects of the present invention are not limited to such a configuration, and the controller may be connected to the 3D printer via a communication unit. In addition, an embodiment of the present invention can be implemented by a software program that converts three-dimensional data.

Furthermore, the above Examples have illustrated the controller on which the processors and data memories are mounted. However, the processors and data memories may be connected via a network, and an embodiment of the present invention is not limited to such a configuration.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

A remaining amount of material usable for forming a three-dimensional object is compared with a material amount to be used to form a three-dimensional object on the basis of three-dimensional data for which a formation instruction is made, and a notification as to whether or not the formation is possible is displayed. In addition, on the basis of the result, it is possible to propose three-dimensional data for which a three-dimensional object can be formed. Thus, a user can avoid failure of formation and can also select the execution of formation using the remaining material efficiently.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modified external dimensions and equivalent structures and functions.

This application claims the benefit of Japanese Patent Application No. 2015-048507, filed Mar. 11, 2015, which is hereby incorporated by reference herein in its entirety.

What is claimed is:

1. A three-dimensional object forming system, comprising:
a forming unit configured to form a three-dimensional object;
a detecting unit configured to detect a remaining amount of material for forming the three-dimensional object;
an input unit configured to input three-dimensional data;
a converting unit configured to convert the three-dimensional data;
a calculating unit configured to calculate a material amount to be used to form the three-dimensional object; and
a display unit configured to display the three-dimensional data,
wherein, based on a result of comparison between the detected remaining amount of the material and the material amount to be used, information displayed on the display unit is changed.

2. The three-dimensional object forming system according to claim 1,
wherein the converting unit converts the three-dimensional data into slice data, and
wherein, if the detected remaining amount of material is less than the material amount to be used to form the three-dimensional object, the system displays a message indicating that it is not possible to normally complete formation of the three-dimensional object.

3. The three-dimensional object forming system according to claim 1,
wherein the converting unit converts the three-dimensional data into stereolithography (STL) data, and
wherein, if the detected remaining amount of material is less than the material amount to be used to form the three-dimensional object, the system does not convert the three-dimensional data into slice data and displays a message indicating that it is not possible to normally complete formation of the three-dimensional object.

4. The three-dimensional object forming system according to claim 1,
wherein, if the detected remaining amount of material is less than the material amount to be used to form the three-dimensional object, the display unit displays, as a prediction result, external dimensions with which formation of the three-dimensional object is possible and which are calculated from the remaining amount of material.

5. The three-dimensional object forming system according to claim 1, further comprising:
a unit configured to receive a command to continue an instruction for forming the three-dimensional object,
wherein, upon receiving the continuation command, based on external dimensions calculated from the remaining amount of material, the system converts the three-dimensional data.

6. The three-dimensional object forming system according to claim 5,
wherein the converting unit configured to, based on external dimensions calculated from the remaining amount of material, convert the three-dimensional data includes any one of:
a unit configured to convert the three-dimensional data such that the external dimensions are scaled down equally in X, Y, and Z coordinate axes,
a unit configured to convert the three-dimensional data such that the external dimensions are scaled down in one of the X, Y, and Z coordinate axes, or
a unit configured to convert the three-dimensional data such that a wall thickness is reduced without changing the external dimensions.

7. The three-dimensional object forming system according to claim 1, further comprising:
a unit configured to receive a command to continue an instruction for forming the three-dimensional object,
wherein, upon receiving the continuation command, the system starts to form the three-dimensional object with external dimensions calculated from the remaining amount of material.

8. The three-dimensional object forming system according to claim 1,
wherein, if the detected remaining amount of material is greater than a material amount to be used for maximum external dimensions of the three-dimensional object that a three-dimensional object forming apparatus forms, the system does not perform control in which the material amount to be used to form the three-dimensional object is calculated or control in which the material amount to be used is compared with the remaining amount of material.

9. The three-dimensional object forming system according to claim 1,
wherein, if external dimensions calculated from the detected remaining amount of material are less than or equal to a predetermined percentage relative to 100% completion percentage of the three-dimensional object, data conversion is not performed.

10. The three-dimensional object forming system according to claim 1, further comprising:
a unit configured to allow setting of not performing data conversion regardless of a completion percentage of a three-dimensional object with external dimensions that are calculated from the detected remaining amount of material.

11. The three-dimensional object forming system according to claim 1,
wherein the detecting unit configured to detect a remaining amount of material usable for forming the three-dimensional object and the calculating unit configured to calculate a material amount to be used to form the three-dimensional object allow an amount of a support material to be included in the material amount.

12. The three-dimensional object forming system according to claim 1,
wherein the calculating unit configured to calculate a material amount to be used to form the three-dimensional object calculates the material amount from slice data.

13. The three-dimensional object forming system according to claim 1,
wherein the calculating unit configured to calculate a material amount to be used to form the three-dimensional object calculates the material amount from stereolithography (STL) data, and
wherein, if the detected remaining amount of material is less than the calculated material amount to be used, the system does not perform conversion from the three-dimensional data into slice data.

14. A method for forming a three-dimensional object, the method comprising:
forming a three-dimensional object;
detecting a remaining amount of material for forming the three-dimensional object;
inputting three-dimensional data;
converting the three-dimensional data;
calculating a material amount to be used to form the three-dimensional object; and
displaying the three-dimensional data,
wherein, the three-dimensional data to be displayed is changed based on a result of comparing the detected remaining amount of the material and the material amount to be used.

15. A computer-readable storage medium storing computer executable instructions that cause a computer to execute a method for forming a three-dimensional object, the method comprising:
forming a three-dimensional object;
detecting a remaining amount of material for forming the three-dimensional object;
inputting three-dimensional data;
converting the three-dimensional data;
calculating a material amount to be used to form the three-dimensional object; and
displaying the three-dimensional data,
wherein, the three-dimensional data to be displayed is changed based on a result of comparing the detected remaining amount of the material and the material amount to be used.
